(19) United States
(12) Patent Application Publication
(10) Pub. No.: US 2008/0318783 A1
(43) Pub. Date: Dec. 25, 2008

(54) Use of abscisic acid seed treatment to enhance corn emergence after early planting

(76) Inventors: Dale O. Wilson, JR., Round Lake Beach, IL (US); Nicole Higgs, Racine, WI (US); Franklin Paul Silverman, Highland Park, IL (US); Peter D. Petracek, Grayslake, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/214,681

(22) Filed: Jun. 20, 2008

Related U.S. Application Data
(60) Provisional application No. 60/936,500, filed on Jun. 20, 2007.

(51) Int. Cl. A01N 43/54; A01N 37/10; A01P 21/00

(52) U.S. Cl. 504/136; 504/307

(57) ABSTRACT

This invention describes the use of S-(+)-abscisic acid (ABA) or ABA analogs or ABA derivatives alone or with guanylate cyclase activators as seed treatments to improve the survival of corn seeds and seedlings when low temperature occurs after planting.

### FIELD OF THE INVENTION

The present invention is directed to improving the emergence of corn (Zea mays) seed after planting under early, cold seedbed conditions.

### BACKGROUND OF THE INVENTION

S-(+)-abscisic acid (ABA) is a plant hormone that is found in all photosynthetic organisms (Cutler and Krochko, 1999; Finkelstein and Rock, 2002). ABA is involved in many major events of plant growth and development including dormancy, germination, bud break, flowering, fruit set, general growth and development, stress tolerance, ripening and abscission. Soluble guanylate cyclase (sGC) is an enzyme that catalyzes the conversion of guanosine triphosphate to cyclic guanosine monophosphate (Coggins, M. P., and K. D. Bloch. 2007. Arterioscler Thromb Vasc Biol 27:1877-1885).

### SUMMARY OF THE INVENTION

The present invention involves treatment of corn seeds with ABA, ABA analogs or ABA derivatives, alone or with sGC activators for the purpose of increasing the resistance of germinating seed and seedlings to cold conditions (0-8° C.) during the first few weeks after planting.

### DETAILED DESCRIPTION OF THE INVENTION

This invention is directed to the treatment of dry seed with S-(+)-abscisic acid (ABA; S-ABA; CAS no. 21293-29-8), analogs of ABA or derivatives of ABA alone or in combination with sGC-activators. Such treatment produces cold tolerance of the seedlings and the germinating seed.

For the purposes of this application, abscisic acid analogs are defined by Structures 1, 2, and 3, wherein for Structure 1:

the bond at the 2-position of the side chain is a cis- or trans-double bond,

the bond at the 4-position of the side chain is a trans-double bond or a triple bond,

the stereochemistry of the alcoholic hydroxyl group is S—, R— or an R,S— mixture, the stereochemistry of the R₁ group is in a cis-relationship to the alcoholic hydroxyl group,

R₁ is ethynyl, ethenyl, cyclopropyl or trifluoromethyl, and
R₂ is hydrogen or lower alkyl;

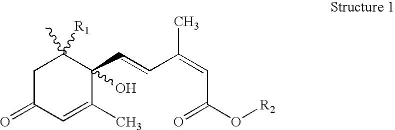

wherein lower alkyl is defined as containing 1 to 4 carbon atoms in a straight or branched chain, which may comprise one ring or contain at least one double bond when 3 or more carbon atoms are present.

A presently preferred compound of structure 1 is PBI-429 where R₁ is ethynyl, and R₂ is a methyl group.

### For Structure 2:

the bond at the 4-position of the side chain is a triple bond,

the bond at the 2-position of the side chain is a trans-double bond or a cis-double bond,

the stereochemistry of the alcoholic hydroxyl group is S—, R— or an R,S— mixture, and R₁ is hydrogen or lower alkyl;

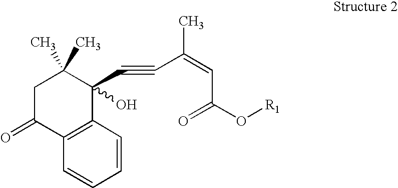

wherein lower alkyl is defined as containing 1 to 4 carbon atoms in a straight or branched chain, which may comprise one ring or contain at least one double bond when 3 or more carbon atoms are present.

A presently preferred compound of structure 2 is PBI-702 where R₁ is a methyl group.

### For Structure 3:

the bond at the 2-position of the side chain is a cis- or trans-double bond,

the bond at the 4-position of the side chain is a trans-double bond or a triple bond,

the stereochemistry of the alcoholic hydroxyl group is S—, R— or an R,S— mixture, and R₁ is hydrogen or lower alkyl;

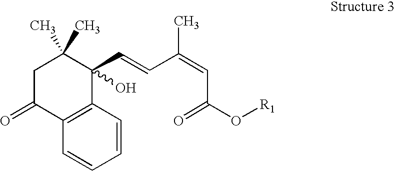

wherein lower alkyl is defined as containing 1 to 4 carbon atoms in a straight or branched chain, which may comprise one ring or contain at least one double bond when 3 or more carbon atoms are present.

A presently preferred compound of structure 3 is PBI-488 where R₁ is a methyl group.

Activators of soluble guanylate cyclase include, but are not limited to YC-1 (3-(5′-hydroxymethyl-2′-furyl)-1-benzylindazole) and BAY 41-2272 (5-cyclopropyl-2-[1-(2-fluoro-benzyl)-1H-pyrazolo[3,4-b]pyridine-3-yl]pyrimidin-4-ylamine).

Depending on the species and the amount of delay needed, the amount of ABA applied to seeds can vary within wide ranges and is generally in the range of about 0.5 grams to 2000 grams, preferably from 5 grams to 200 grams, per 100 pounds of seed. Applications made to seedlings may range from 10 to 10,000 ppm, preferably from 100 to 1000 ppm, depending on the application volume and amount of flowering delay needed.

When sGC-activators are used in combination with ABA, its derivatives or its analogs, they are generally present in an amount ranging from 0.1 to 50 ug/seed, preferably 1 to 20 ug/seed.

The ratio of ABA to the sGC-activator is from 20:1 to 2:1.

### EXAMPLES

### Example 1

### Effect of Dip Treatments with ABA and an Aba Analog on Cold Damage in 2-Day Old Corn Seedlings

### Method

Corn (“Hughes High” variety) was germinated in the dark in moist rolled towels at 25° C. for 2 days. Seedlings were selected that were undamaged, with a radicle of 1-2 cm and a coleoptile of 0.5 to 1 cm in length. Solutions in water with 5% ethanol were made with different concentrations of ABA and PBI-429. The seedlings were dipped in the solutions with gentle agitation for approximately 30 seconds and drained. The seedlings were placed on moist towels, gently rolled and held at 18° C. for 16 hours. Then the rolled towels were packed in ice for four days. After the chilling period, the rolled towels were blotted to remove excess water and transferred to a 25° C. chamber. Seedling damage was scored 3 days later. Lethal injury of the shoot consisted of either destruction of the mesocotyl or splitting or reduction of the coleoptile judged sufficient to prevent emergence of seedlings in the field (although this trial was conducted in towels). Seedlings with destroyed roots had no living primary or seminal roots. Seedlings with adventitious root growth from the mesocotyl were counted.

### Results

TABLE 1
Responses of 2-day corn seedlings to brief dips with ABA
solutions followed by exposure to 0° C. for 4 days.

| ABA | Lethal | Destroyed | Adventitious root |
|---|---|---|---|
| dose (ppm) | shoot (%) | roots (%) | growth (%) |
| 0 | 76 | 90 | 0 |
| 10 | 62 | 86 | 7 |
| 100 | 47 | 84 | 20 |
| 1000 | 11 | 48 | 89 |

TABLE 2
Responses of 2-day corn seedlings to brief dips with
solutions of an ABA analog (PBI-429) solutions followed
by exposure to 0° C. for 4 days.

| PBI-429 | Lethal | Destroyed | Adventitious root |
|---|---|---|---|
| dose (ppm) | shoot (%) | roots (%) | growth (%) |
| 0 | 76 | 90 | 0 |
| 1 | 78 | 80 | 14 |
| 10 | 52 | 87 | 11 |
| 100 | 24 | 64 | 69 |

These results show that ABA or ABA analogs applied to the seedling prior to cold stress, can provide protection from injury, and stimulate adventitious root growth (Tables 1 and 2).

### Example 2

### Effect of Seed Treatment with ABA on Cold Damage During Germination

### BACKGROUND

Commercial seed treatment is performed by spraying a small volume of an aqueous slurry onto the seeds just prior to bagging. New ingredients must be compatible with this system. The slurry usually includes a fungicide, a film forming agent and a colorant. The process is simulated in the laboratory by preparing small samples of slurry, and spraying them onto the seed in a laboratory-scale seed-coating machine. The purpose of this experiment was to evaluate the feasibility of commercial seed treatment with ABA, and to determine what effect such treatment might have on resistance to severe chilling stress during the germination period.

### Method

ABA was applied to corn seed at 0, 1, 5, 25 and 125 g/cwt (seed weight basis). The ABA was first converted to the sodium salt to render it soluble before making up the experimental seed treatment slurries. The treatments were made up in 3 ml samples of an aqueous slurry. All of the seed treatment slurry samples contained CF-Clear film-forming agent and Colorcoat Red (Becker Underwood), each at loz/cwt, and 0.167 oz/cwt Maxim XL fungicide (Syngenta). The slurry application volume was 20 oz/cwt (cwt=100 lbs of seed). One hundred gram samples of “Hughes High” hybrid corn seed were treated with the experimental slurries using a Hege 11 seed treater with a six-inch bowl.

Three replications of 50 seeds each were planted were planted in moist towels and germinated in the dark at 25° C. for 48 hours. The rolled towels were then packed in ice for 4 days. After the cold period the towels were blotted and germination continued until the seedlings were large enough so that each seedling could be scored. In the case of the 125 g rate, this took 2 weeks. Seedling organs were scored independently for damage to the primary root, seminal roots, mesocotyl, coleoptile and the scutellar node. A seedling was judged to exhibit lethal shoot injury if the axis was severed above the scutellar node, or the coleoptile was sufficiently distorted so as to render the seedling unable to penetrate soil. A seedling was judged to exhibit lethal root injury if no non-necrotic root tissue was observed at or below the scutellar node, or if the scutellar node had been destroyed. A seedling was rated as “Strong” if it was anatomically complete and exhibited no lesions.

### Results

TABLE 3
Seedlings with lethal root or shoot injury from severe chilling during
germination, after treatment of the dry seed with different doses of ABA.

| | | Seedlings with | Seedlings with |
|---|---|---|---|
| ABA dose | Strong | lethal shoot | lethal root |
| (g/cwt) | seedlings (%) | injury (%) | injury (%) |
| 0 | 7.5 | 45.9 | 54.8 |
| 1 | 18.0 | 19.3 | 23.3 |
| 5 | 88.7 | 8.0 | 0.7 |
| 25 | 95.3 | 15.5 | 0.0 |
| 125 | 81.3 | 11.4 | 0.7 |

These results demonstrate that ABA can be delivered to the germinating seed by treating the dry seed with ABA (Table 3). Further, these results show that ABA treatment is compatible with standard commercial practice.

### Example 3

### Effect of Seed Treatment with Aba on Survival of Corn Seedlings in Soil Tests Subjected to Cold

### Method

Corn seed (Hughes 1883) was treated with ABA ammonium salt as described under Example 2. ABA rates of 0, 5, 10 and 25 g/cwt were applied.

The seed was planted in plastic boxes containing lkg of typical agricultural silt loam. Fifty seeds were planted 3 cm deep in each plastic box, and the soil in the box was adjusted to 23% soil moisture (wet-weight basis). Two replications of the experiment were performed. Two kinds of cold tolerance assays were conducted, “standard delayed chilling” and “chilling at spiking.” The boxes for the standard delayed chilling were held at for 2 days and transferred to 1° C. for four days. Boxes for the “chilling at spiking” treatment were allowed to germinate at 25° C. until the coleoptiles were first observed emerging from the soil. This common point of development varied from 3 to 6 days depending upon the dose of ABA. Then these boxes too were transferred to the 1° C. chamber for four days.

After the cold treatment the boxes were moved to the 25° C. chamber for one week. The soil was washed from the seedlings and each seedling scored for damage as described under Example 2. “Viable seedlings” were seedlings capable of surviving under typical field conditions. Such seedlings exhibited an intact root-shoot axis, coleoptile without major splits or distortion and some living root tissue. “Strong seedlings” were anatomically complete and exhibited no lesions.

### Results

TABLE 4
Soil test results from seeds treated with ABA and subjected
to severe chilling after 2 days germination.

| ABA dose (g/cwt) | Strong seedlings (%) | Viable seedlings (%) |
|---|---|---|
| 0 | 0 | 2 |
| 5 | 53 | 99.5 |
| 10 | 96 | 99.5 |
| 25 | 100 | 100 |

These results show that ABA can be delivered as a seed treatment to produce protection of germinating seeds and young seedlings in field soil (Table 4).

TABLE 5
Soil test results from seeds treated with ABA and subjected to severe
chilling applied just at the point of initial emergence (spiking assay).

| ABA dose (g/cwt) | Strong seedlings (%) | Viable seedlings (%) |
|---|---|---|
| 0 | 0 | 0 |
| 5 | 0 | 5 |
| 10 | 18 | 62 |
| 25 | 10 | 23 |

These results demonstrate that protection of seedlings from cold damage produced by seed treatment with ABA, results not only from delay of germination, but from induction of cold tolerance in the tissue (Table 5).

### Example 4

### Effect of Seed Treatment with ABA and Stimulators of Guanylate Cyclase on Cold damage during germination

### Method

Corn seed (Hughes 5813) was treated with sodium ABA salt as described under Example 3. ABA rates of 0 and 20 ug/seed were applied either alone or with compounds that are selective and potent activators of soluble guanylate cyclase in animal and plant cells. These agent are YC-1 (3-(5′-hydroxymethyl-2′-furyl)-1-benzylindazole) and BAY 41-2272 (5-cyclopropyl-2-[1-(2-fluoro-benzyl)-1H-pyrazolo[3,4-b]pyridine-3-yl]pyrimidin-4-ylamine).

### Results

TABLE 6
Percent strong or viable seedlings following cold damage
during germination, after treatment of the dry seed with
different doses of YC-1 and ABA.

| | Percent Strong Seedlings | | Percent Viable Seedlings | |
|---|---|---|---|---|
| YC-1 Dose | ABA Dose (μg/seed) | | ABA Dose (μg/seed) | |
| (μg/seed) | 0 | 20 | 0 | 20 |
| 0 | 0 | 67 | 49 | 100 |
| 1 | 0 | 75 | 44 | 99 |
| 10 | 4 | 96 | 46 | 99 |

TABLE 7
Percent strong or viable seedlings following cold damage
during germination, after treatment of the dry seed with
different doses of Bay 41-2272 and ABA.

| | Percent Strong Seedlings | | Percent Viable Seedlings | |
|---|---|---|---|---|
| Bay 41-2272 | ABA Dose (μg/seed) | | ABA Dose (μg/seed) | |
| Dose (μg/seed) | 0 | 20 | 0 | 20 |
| 0 | 0 | 67 | 49 | 100 |
| 1 | 1 | 85 | 65 | 97 |
| 10 | 0 | 93 | 64 | 100 |

These results in Tables 6 and 7 demonstrate that sGC activators alone have little effect on cold damage, but sGC activators combined with ABA can protect seedlings from damage by cold more than ABA alone. These results suggest that ABA activity for protection from cold damage could be enhanced by increased production or maintenance of cyclic nucleotides in plant cells, using agents such as BAY 41-2272.

1. A method of improving cold tolerance a final stand or the yield of a plant comprising applying an effective amount of S-(+)-abscisic acid or a derivative or analog thereof to a seed of said plant.

2. The method of claim 1, wherein said plant is corn.

3. The method of claim 1, wherein said effective amount is from about 0.5 grams to about 2000 grams per 100 pounds of said seed.

4. The method of claim 1, wherein said effective amount is from about 10 ppm to about 10,000 ppm.

5. A composition for enhancing plant growth comprising abscisic acid or abscisic acid derivative or analog and a compound that activates guanylate cyclase.

6. A composition as in claim 5 where the compound that activates guanylate cyclase is 3-(5′-hydroxymethyl-2′-furyl)-1-benzylindazole.

7. A composition as in claim 5 where the compound that activates guanylate cyclase is 5-(cyclopropyl-2-[1-(2-fluorobenzyl)-1H-pyrazolo[3,4-b]pyridine-3-yl]pyrimidin-4-ylamine.

8. A method of enhancing the growth of plants or improving cold tolerance of plants by applying an effective amount of the composition of claim 7 to seeds or the root zone of seedlings or plants.

9. The method of claim 8 wherein the plant is corn.
